(19) United States
(12) Patent Application Publication
(10) Pub. No.: US 2025/0233172 A1
(43) Pub. Date: Jul. 17, 2025

(54) FUEL CELL SYSTEM

(71) Applicant: ROLLS-ROYCE plc, London (GB)

(72) Inventors: Chloe PALMER, Derby (GB); Jacopo TACCONI, Derby (GB)

(73) Assignee: ROLLS-ROYCE plc, London (GB)

(21) Appl. No.: 18/701,737

(22) PCT Filed: Oct. 4, 2022
(86) PCT No.: PCT/EP2022/077521

§ 371 Date: Apr. 16, 2024

(30) Foreign Application Priority Data
Oct. 28, 2021 (GB) 2115487.7

(51) Int. Cl. H01M 8/04007; B64D 31/18; B64D 33/08; H01M 8/04014; H01M 8/04111; H01M 8/0662; H01M 8/10; H01M 8/1018

(52) U.S. Cl. CPC H01M 8/04059; B64D 31/18; B64D 33/08; H01M 8/04022; H01M 8/04111; H01M 8/0662; H01M 8/1018; H01M 2008/1095

(57) ABSTRACT

A fuel cell system includes a fuel cell stack and a cooling circuit arranged to cool the stack by implementing a Rankine cycle. The cooling circuit includes the stack, a heater arranged to heat coolant fluid in the cooling circuit, a turbine and a condenser in that order and an apparatus arranged to drive coolant fluid around the cooling circuit. A conveying device provides a flow of liquid hydrogen from an input a position at or near the heater, such that some or all of the flow is vaporised, and a flow of resulting gaseous hydrogen from the position to a hydrogen fuel input of the stack such that the gaseous hydrogen is in thermal contact with coolant fluid in the condenser. Cooling of coolant fluid within the condenser is thereby assisted, allowing the condenser to be reduced in size and weight.

### TECHNICAL FIELD

The invention relates to fuel cell systems.

### BACKGROUND

Fuel cell systems, especially those which use hydrogen as a fuel, are of interest for use in transport applications, including aviation, as they offer the possibility of operating without production of carbon dioxide at the point of use. Such systems are also of interest in marine applications and for stationary power generation. Removal of heat from a fuel cell stack comprised in a fuel cell system is a key design consideration. However, certain types of fuel cell stack have relatively low operating temperatures which can lead to technical challenges in heat removal due to a low temperature difference with respect to ambient temperature. For example, a low-temperature polymer electrolyte (proton exchange) membrane (PEM) fuel cell stack typically has an operating temperature of less than about 90° C. In this case, a simple cooling system requires the use of large coolant/air heat exchanger, adding substantial weight to a fuel cell system comprising the stack and tending to preclude use of such a system in aeronautical applications. Another approach to cooling a fuel cell stack is by means of cooling apparatus which implements a Rankine cycle to recover useful work from waste heat produced by the fuel cell stack. However, in the case of a fuel cell stack with a low operating temperature, the amount of work which can be extracted is limited, as is the efficiency of work extraction.

It is known to increase the work extracted per unit time, and its efficiency of extraction, by adding heat to coolant fluid within a cooling circuit implementing a Rankine cycle between the fuel cell stack and turbine of the cooling circuit (e.g. published patent applications US 2002/0055024A1, EP 1207 580A1 and patents U.S. Pat. No. 3,982,962, EP 2639 414B1). However, such a Rankine cooling circuit also requires a condenser having a size and weight compromising the overall gravimetric power density of the fuel cell system, making it unattractive for vehicle propulsion, especially aircraft propulsion. Use of hydrogen boiled-off from a store of liquid hydrogen for the purpose of cooling a condenser in a Rankine cooling circuit associated with a PEM fuel cell stack is disclosed in the paper “Exergy and exergoeconomic comparison between multiple novel combined systems based on proton exchange membrane fuel cells integrated with organic Rankine cycles, and hydrogen boil-off gas subsystem” by S. Marandi et al, Energy Conversion and Management 244 (2021), article 114532.

### BRIEF SUMMARY

A first aspect of the invention provides a fuel cell system comprising a fuel cell stack and a cooling circuit arranged to cool the fuel cell stack by implementing a Rankine cycle which converts waste heat from the fuel cell stack into useful work during operation of the fuel cell system, the cooling circuit including the fuel cell stack, a heater arranged to heat coolant fluid in the cooling circuit, a turbine and a condenser arranged in that order and means arranged to drive coolant fluid around the cooling circuit and wherein the cooling circuit is arranged such that during operation of the fuel cell system the coolant fluid is in gaseous form between the heater and the condenser and in liquid form between the condenser and the fuel cell stack, characterised in that the fuel cell system further comprises conveying means arranged to provide a flow of liquid hydrogen to a position at or near the heater and a flow of gaseous hydrogen from said position to a hydrogen fuel input of the fuel cell stack via the condenser such that the gaseous hydrogen is in thermal contact with coolant fluid in the condenser and the heater is arranged to vaporise at least a portion of the flow of liquid hydrogen to generate the flow of gaseous hydrogen.

The addition of heat to coolant fluid in the cooling circuit between the fuel cell stack and the turbine by means of the heater achieves the following: (1) an increase in the amount of power extracted by turbine and an increase in thermodynamic efficiency of work extraction by the turbine; (2) completion of a change of phase of the coolant fluid from liquid to gas within the cooling circuit between the fuel cell stack and the turbine if the change of phase is incomplete when the coolant fluid exits the fuel cell stack; and (3) improved control of the temperature of the coolant fluid on entry to the turbine. Coolant fluids with higher boiling points than those typically associated with organic fluids may be used because any coolant fluid leaving the fuel cell stack still in liquid form is vaporised by the heater. Cooling of coolant fluid within the condenser is assisted, allowing the size and weight of the condenser to be reduced.

The fuel cell stack may be a polymer electrolyte (proton exchange) membrane (PEM) fuel cell stack, in which case the coolant fluid may be water, a water-glycol mixture of an organic fluid.

Where the fuel cell stack is a PEM fuel cell stack, the heater may be arranged to receive and combust hydrogen output from the PEM fuel cell stack and provide resulting heat to (i) the coolant fluid within the cooling circuit between the PEM fuel cell stack and the turbine and (ii) the flow of liquid hydrogen to vaporise the flow of liquid hydrogen and generate the flow of gaseous hydrogen.

Alternatively, the heater may be arranged to receive a flow of liquid hydrogen and combust a portion of said flow to provide heat to (a) vaporise the remainder of the flow of liquid hydrogen to generate the flow of gaseous hydrogen and (b) to heat the coolant fluid within the cooling circuit between the PEM fuel cell stack and the turbine.

Where gaseous hydrogen output from the PEM fuel cell stack or liquid hydrogen input to the system is combusted in the heater, the fuel cell system may comprise a turbocharger having a compressor and a turbine arranged to drive the compressor, the compressor being arranged to compress ambient air and provide resulting compressed air to an air input of the PEM fuel cell stack, the fuel cell system being arranged to provide combustion products from the heater to the turbine of the turbocharger.

The turbocharger may comprise an electric motor arranged to drive the compressor of the turbocharger and the fuel cell system may further comprise an electrical generator arranged to be driven by the turbine of the cooling circuit and to provide electrical power to the electric motor during operation of the fuel cell system.

A second aspect of the invention provides a propulsion system comprising a fuel cell stack according to the first aspect of the invention and a propulsor arranged to receive electrical power from the fuel cell stack of the fuel cell system and generate propulsive thrust using the electrical power.

### BRIEF DESCRIPTION OF THE DRAWINGS

Embodiments of the invention are described below by way of example only and with reference to the accompanying drawings in which:

FIG. 1 shows a fuel cell system which is not an example of the invention but which is useful for understanding the invention;

FIG. 2 illustrates operation of a Rankine cycle carried out by cooling apparatus comprised in the FIG. 1 fuel cell system;

FIGS. 3, 4 & 5 shows first to third example fuel cell systems of the invention, respectively; and

FIG. 6 shows a propulsion system of the invention comprising the fuel cell system of FIG. 3.

### DETAILED DESCRIPTION

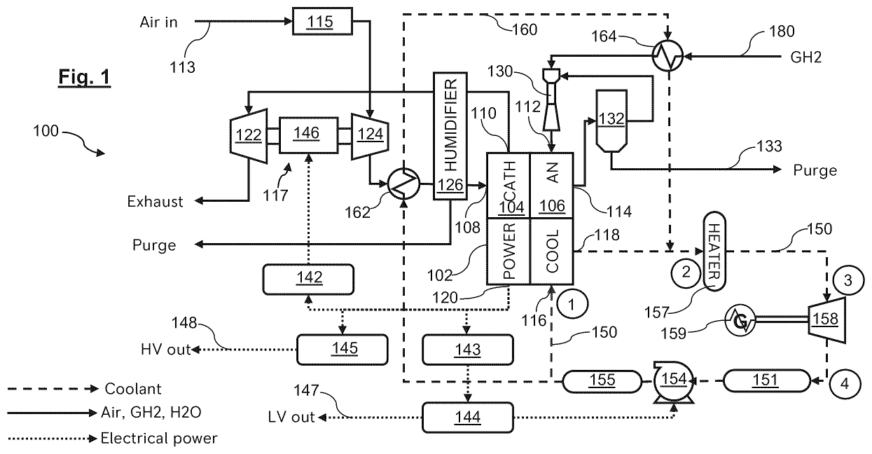

FIG. 1 shows a fuel cell system 100 comprising a polymer electrolyte (proton exchange) membrane (PEM) fuel cell stack 102, a turbocharger 117 comprising a turbine 122 arranged to drive a compressor 124 (possibly with the assistance of an electric motor 146), heat exchangers 162, 164 and a humidifier 126. The PEM fuel cell stack 102 has cathode 104 and anode 106 sides having gas inputs 108, 112 and outputs 110, 114 respectively. Gas input 112 of anode side 106 is a hydrogen fuel input of the PEM fuel cell stack 102. Gas input 108 of cathode side 104 is an air input.

In operation of the fuel cell system 100, gaseous hydrogen fuel (GH2) enters a hydrogen fuel input 180 of the system 100 and is applied to the anode input (hydrogen fuel input) 112 of the PEM fuel cell stack 102 via heat exchanger 164 (which provides heating of the gaseous hydrogen) and an ejector 130. Unused gaseous hydrogen output from the anode output 114 is re-circulated via a water trap 132 and the ejector 130 back to the anode input 112. Gaseous hydrogen may be purged from the anode side 106 of the PEM fuel cell stack 102 via an output 133 of the water trap 132.

Air enters an air intake 113 of the system 100 and passes via an air filter 115 to the compressor 124 of the turbocharger 117, and then via the heat exchanger 162 (which provides cooling of compressed air output from the compressor 124) and the humidifier 126 to the input 108 of the cathode side 104 of the PEM fuel cell stack 102. Exhaust comprising air and water vapour is expelled from the output 110 of the cathode side 104 of the PEM fuel cell stack 102; water vapour is extracted by the humidifier 126 and the remaining exhaust passes to the turbine 122 of the turbocharger 117.

DC electrical power generated by the PEM fuel cell stack 102 of the fuel cell system 100 is output at an electrical output 120 of the PEM fuel cell stack 102 and provided to low-voltage and high-voltage DC/DC converters 143, 145 respectively, and to a DC/AC inverter 142. AC electrical power from the inverter 142 is provided to the electric motor 146. High-voltage output from the high-voltage DC/DC converter 145 is provided at an electrical output 148 and may be provided to an electric propulsor (not shown) for example. Low-voltage output from the low voltage DC/DC converter 143 is provided to a low-voltage bus 144 which supplies a coolant pump 154 within a cooling circuit 150 of the fuel cell system 100 with low-voltage electrical power. The low-voltage bus 144 also supplies a low-voltage system output 147.

The cooling circuit 150 is arranged to implement a Rankine cycle during operation of the fuel cell system 100 in order to cool the PEM fuel cell stack 102 and recover useful work from waste heat output therefrom. The cooling circuit 150 includes the PEM fuel cell 102, a heater 157, a turbine 158 arranged to drive an electrical generator 159, a condenser 151, the coolant pump 154 and a de-ioniser 155. The PEM fuel cell stack 102 has a coolant fluid input 116 and a coolant fluid output 118. A cooling branch 160 arranged in parallel with the PEM fuel cell stack 102 includes the heat exchangers 162, 164. The coolant pump 154 is arranged to drive coolant fluid (in this example water) around the cooling circuit 150 and through the cooling branch 160. Coolant fluid within heat exchanger 162 absorbs heat from compressed air output from the compressor 124; coolant fluid within heat exchanger 164 loses heat to gaseous hydrogen fuel input to the hydrogen fuel input 190 of the system 100.

During operation of the fuel cell system 100, coolant fluid within the cooling circuit 150 is in liquid form between the condenser 151 and the PEM fuel cell stack 102, and in gaseous form between the heater 157 and the condenser 151. Coolant fluid enters the PEM fuel cell stack 102 at the coolant fluid input 116 in liquid form, absorbs waste heat from the PEM fuel cell stack 102 so that some or all of the liquid water is converted to gaseous form (i.e. steam), and exits the PEM fuel cell stack 102 at the coolant fluid output 118. The extent of conversion depends on the operational state of the PEM fuel cell stack 102 and the pressure within the cooling circuit 150. The coolant fluid is heated by the heater 157, converting any remaining liquid water output at the coolant fluid output 118, and liquid water received from the cooling branch 160, to steam; the gaseous coolant fluid (i.e. steam) then passes to the turbine 158 which extracts work from the gaseous coolant fluid and drives the generator 159. Electrical power output from the generator 159 may for example be used to assist in driving the electric motor 146 of the turbocharger 117, or for some other purpose. Gaseous coolant fluid is returned to liquid form by the condenser 151.

Heat is supplied to the heater 157 from an external source (not shown). For example, waste heat from some other apparatus, for example a gas turbine engine, may be provided to the heater 157.

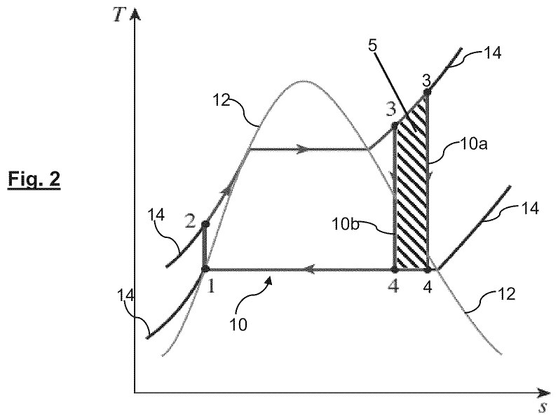

FIG. 2 shows a plot 10 of temperature T versus entropy S for coolant water within the cooling circuit 150 of the fuel cell system 100 of FIG. 1. The cooling circuit 150 performs a Rankine cycle to convert waste heat from the PEM fuel cell stack 102 into useful work extracted by the turbine 158. Positions in the cooling circuit 150 at the coolant fluid input 116 and immediately before the heater 157 are labelled 1 and 2 respectively in FIGS. 1 and 2; positions immediately before and after the turbine 158 are labelled 3 and 4 respectively. The work extracted by the turbine 158 is represented by the area enclosed by the plot 10, which has a portion 10a representing the change in temperature T and entropy S of the coolant fluid (steam) across the turbine 158. In the absence of the heater 157, the plot 10 has a portion 10b representing the change in temperature T and entropy S of the coolant fluid (steam) across the turbine 158. The area 5 in FIG. 2 therefore represents an additional amount of work extracted by the turbine 158 due to the presence of the heater 157 within the cooling loop 150. The liquid/gas phase separation line for the coolant fluid is indicated by 12 in FIG. 2. Lines of constant pressure are indicated by 14.

The thermodynamic efficiency nₜₕ with which net work wₙₑₜ is extracted by the Rankine cycle is

$${η}_{th} = \frac{{w}_{net}}{{Q}_{in}} = \frac{{Q}_{in} - {Q}_{out}}{{Q}_{in}} = 1 - \frac{{Q}_{out}}{{Q}_{in}}$$

where Qᵢₙ is the heat input to the coolant fluid by the PEM fuel cell stack 102 plus the heat input to the coolant fluid by the heater 157, and Qₒᵤₜ is the heat output from the condenser 151. The net work wₙₑₜ is the difference between the work extracted by the turbine 158 and the work carried out by the pump 154. If hᵢ is the enthalpy at position i, where i=1, 2, 3 or 4, the thermodynamic efficiency nₜₕ is given by

$${η}_{th} = \frac{{w}_{net}}{{Q}_{in}} = \frac{( {h}_{3} - {h}_{4} ) - ( {h}_{2} - {h}_{1} )}{( {h}_{3} - {h}_{2} )} = 1 - \frac{{h}_{4} - {h}_{1}}{{h}_{3} - {h}_{2}}$$

The thermodynamic efficiency with which work is extracted by the turbine 158 is therefore also increased by the presence of the heater 157 (in addition to an increase in the absolute amount of work extracted) since the enthalpy h₃ of the coolant fluid at position 3 (immediately before the turbine 158) is greater than h₃ in the absence of the heater 157, so that the value h₃-h₂ is increased by the heater 157.

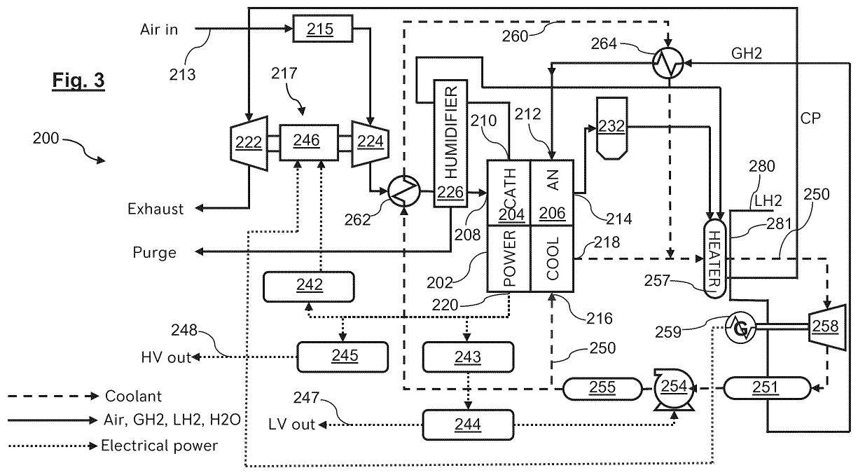

FIG. 3 shows a first example fuel cell system of the invention indicated generally by 200. The fuel cell system 200 is similar to the fuel cell system 100 of FIG. 1; parts of the system 200 are labelled with reference signs differing by 100 from those labelling corresponding parts in FIG. 1. In operation of the fuel cell system 200, air from cathode output 210 of PEM fuel cell stack 202 is input to heater 257 via humidifier 226 (which removes water vapour), together with gaseous hydrogen output from hydrogen output 214 of stack 202 via water trap 232. The hydrogen output from anode side 206 of PEM fuel cell stack 202 is combusted to provide heating of coolant fluid within cooling circuit 250, allowing more work to be extracted to be extracted by turbine 258, and with increased thermodynamic efficiency, than in the absence of the heater 257. The heater 257 may be a catalytic burner. The fuel cell system 200 provides continuous purging of the anode side 206 of the PEM fuel cell stack 202, purged hydrogen being combusted to increase the work extracted by turbine 258 and also the thermodynamic efficiency with which it is extracted. Continuous purging provides for continuous electrical power to be generated by the PEM fuel cell stack 202. Combustion products (CP) output from the heater 257 are provided to turbine 222 of turbocharger 217. Electrical power generated by generator 259 is provided to electric motor 246 of turbocharger 217. Liquid hydrogen (LH2) is supplied to the fuel cell system 200 at a LH2 input 280 and conveyed by conveying means 281 to a position at or hear heater 257. Heat from the heater 257 vaporises liquid hydrogen in the conveying means 281; resulting gaseous hydrogen (GH2) passes to hydrogen fuel input 212 of PEM fuel cell stack 202 via condenser 251 and heat exchanger 264, such that the gaseous hydrogen is in thermal contact/communication with coolant fluid in the condenser 251. The heater 257 thus heats and vaporises liquid hydrogen input to the fuel cell system 200 in addition to heating coolant fluid in cooling circuit 250. The resulting gaseous hydrogen cools coolant fluid in condenser 251. The gaseous hydrogen is heated by the condenser 251 and heat exchanger 264 prior to being input to PEM fuel cell stack 202 at hydrogen fuel input 212.

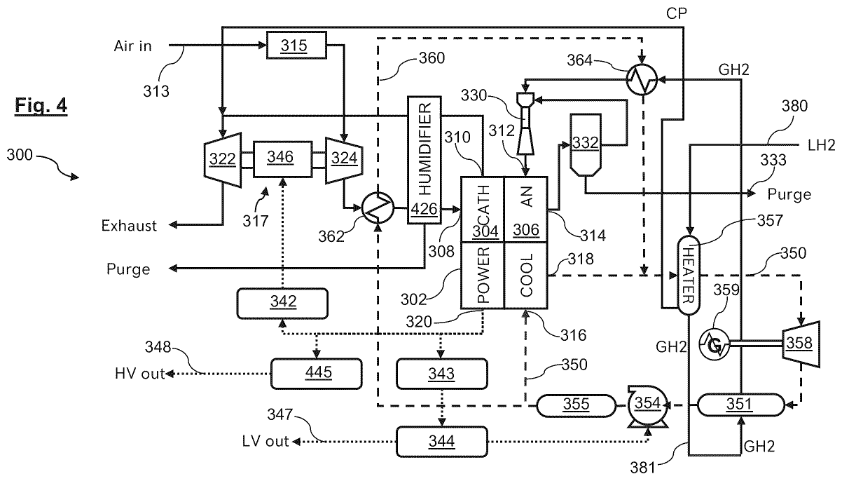

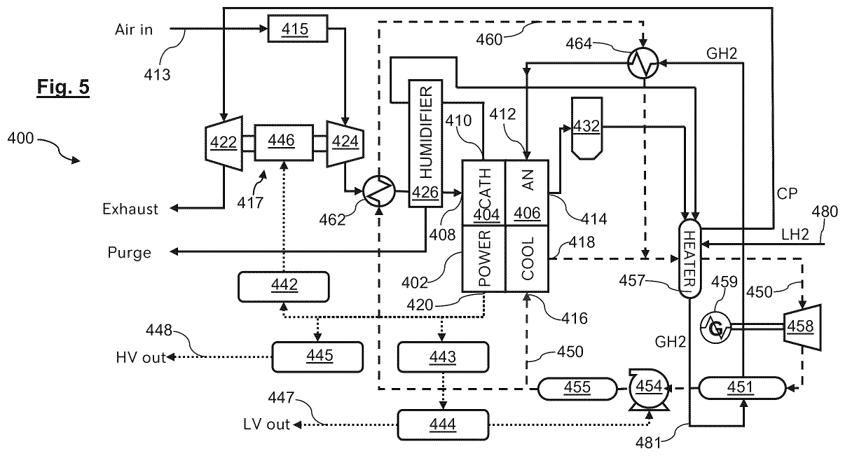

FIG. 4 shows a second example fuel cell system of the invention, indicated generally by 300. The fuel cell system 300 is similar to the fuel cell system 100; parts of the system 300 are labelled with reference signs differing by 200 from those labelling the corresponding parts in FIG. 1. The fuel cell system 300 has a liquid hydrogen (LH2) input 380, from where a flow of liquid hydrogen passes to heater 357. A portion of the flow liquid hydrogen is combusted by the heater 357, providing heat which heats coolant fluid within coolant circuit 350 and which converts the remainder of the flow of liquid hydrogen into gaseous hydrogen. The gaseous hydrogen passes to hydrogen fuel input 312 of PEM fuel cell stack 302 via conveying means on a path such that the gaseous hydrogen is in thermal contact with coolant fluid within condenser 351 and heat exchanger 364. The gaseous hydrogen provides cooling of coolant fluid within the condenser 351, thus allowing a reduction in size of an air/coolant heat exchanger comprised in the condenser 351 compared to the systems 100, 200 of FIGS. 1 and 3. Simultaneously, the gaseous hydrogen is heated. Further heating of the gaseous hydrogen occurs at heat exchanger 364 prior to input of the gaseous hydrogen to the PEM fuel cell stack 302 via ejector 330. Combustion products (CP) from the heater 357 are provided to turbine 322 which is comprised in turbocharger 317.

FIG. 5 shows a third example fuel cell system 400 of the invention. The fuel cell system 400 is similar to the fuel cell system 200 of FIG. 3. Parts of the fuel cell system 400 are labelled with reference signs differing by 200 from those labelling corresponding parts in FIG. 3. In operation of the fuel cell system 400, a flow of liquid hydrogen (LH2) fuel is input to the fuel cell system 400 at fuel input 480 and passes to heater 457 which heats the flow of liquid hydrogen to produce a flow of gaseous hydrogen (GH2) in addition to heating coolant fluid within cooling circuit 450. The gaseous hydrogen is input to anode side 406 of PEM fuel cell stack 402 via conveying means such that the gaseous hydrogen is in thermal contact with coolant fluid within condenser 451 and heat-exchanger 464, allowing the condenser 451 to have reduced size and weight compared to the condenser 251 of the fuel cell system 200 of FIG. 3 for example.

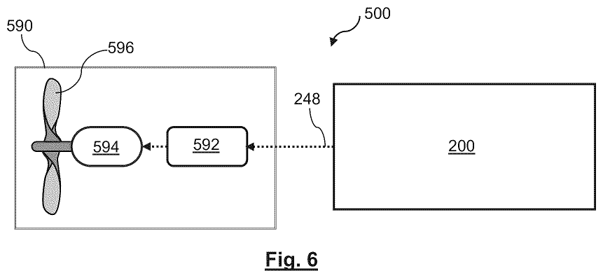

FIG. 6 shows a propulsion system 500 comprising the fuel cell system 200 of FIG. 3 and an electric propulsor 590. The propulsor 590 comprises an inverter 592 arranged to receive DC electrical power from the electrical output 248 of the fuel cell system 200. The inverter 592 provides AC electrical power to an electric motor 594 which is arranged to drive a propeller or fan 596. In further example propulsion systems of the invention, a propulsor such as 590 is driven by electrical power from one of the fuel cell system 300, 400 of FIGS. 4 and 5 respectively.

This application is based upon and claims the benefit of priority from United Kingdom Patent Application No. 2115487.7, filed on Oct. 28, 2021, the entire contents of which are incorporated herein by reference.

1-12. (canceled)

13. A fuel cell system comprising a fuel cell stack and a cooling circuit arranged to cool the fuel cell stack by implementing a Rankine cycle which converts waste heat from the fuel cell stack into useful work during operation of the fuel cell system, the cooling circuit including the fuel cell stack, a heater arranged to heat coolant fluid in the cooling circuit, a turbine and a condenser arranged in that order and means arranged to drive coolant fluid around the cooling circuit and wherein the cooling circuit is arranged such that during operation of the fuel cell system the coolant fluid is in gaseous form between the heater and the condenser and in liquid form between the condenser and the fuel cell stack, wherein the fuel cell system further comprises conveying means arranged to provide a flow of liquid hydrogen to a position at or near the heater and a flow of gaseous hydrogen from said position to a hydrogen fuel input of the fuel cell stack via the condenser such that the gaseous hydrogen is in thermal contact with coolant fluid in the condenser and the heater is arranged to vaporise at least a portion of the flow of liquid hydrogen to generate the flow of gaseous hydrogen.

14. The fuel cell system according to claim 13 wherein the fuel cell stack is a PEM fuel cell stack.

15. The fuel cell system according to claim 14 wherein the coolant fluid is water or a water-glycol mixture or an organic fluid.

16. The fuel cell system according to claim 14 wherein the heater is arranged to receive hydrogen output from the PEM fuel cell stack, combust said hydrogen and provide resulting heat to (i) the coolant fluid within the cooling circuit between the PEM fuel cell stack and the turbine and (ii) the flow of liquid hydrogen to vaporise the flow of liquid hydrogen and generate the flow of gaseous hydrogen.

17. The fuel cell system according to claim 14 wherein the heater is arranged to receive the flow of liquid hydrogen, combust a portion of the flow to provide heat to (a) vaporise the remainder of the flow of liquid hydrogen to generate the flow of gaseous hydrogen and (b) to heat the coolant fluid within the cooling circuit between the PEM fuel cell stack and the turbine.

18. The fuel cell system according to claim 16 and comprising a turbocharger having a compressor and a turbine arranged to drive the compressor, the compressor being arranged to compress ambient air and provide resulting compressed air to an air input of the PEM fuel cell stack, wherein the fuel cell system is arranged to provide combustion products from the heater to the turbine of the turbocharger.

19. The fuel cell system according to claim 18 wherein the turbocharger comprises an electric motor arranged to drive the compressor of the turbocharger, the fuel cell system further comprising an electrical generator arranged to be driven by the turbine of the cooling circuit and to provide electrical power to the electric motor during operation of the fuel cell system.

20. The propulsion system comprising a fuel cell system according to claim 13 and a propulsor arranged to receive electrical power from the fuel cell stack of the fuel cell system and generate propulsive thrust using the electrical power.
